(19) United States
(12) Patent Application Publication
(10) Pub. No.: US 2025/0216288 A1
(43) Pub. Date: Jul. 3, 2025

(54) METHOD FOR EXTRACTING NEAR-FIELD INCIDENT WAVES OF FIXED OFFSHORE ENGINEERING STRUCTURE

(71) Applicants: Ocean University of China, Qingdao City (CN); Zhejiang Huadong Mapping and Engineering safety Technology CO., LTD., Hangzhou (CN)

(72) Inventors: Qiang Liu, Qingdao City (CN); Fushun Liu, Qingdao City (CN); Hong Song, Qingdao City (CN); Xiaoming Zhan, Qingdao City (CN); Mintao Zhu, Qingdao City (CN); Peng Tai, Qingdao City (CN)

(21) Appl. No.: 18/599,271

(22) Filed: Mar. 8, 2024

(30) Foreign Application Priority Data
Dec. 27, 2023 (CN) 2023118312524

(51) Int. Cl. G01M 10/00; G01C 13/00; G06F 17/14

(52) U.S. Cl. CPC G01M 10/00; G06F 17/148; G01C 13/00

(57) ABSTRACT

Disclosed is a method for extracting near-field incident waves of a fixed offshore engineering structure. The method includes the steps: calculating a dimensionless wave height parameter and a dimensionless water depth parameter based on measured wave information, and selecting applicable wave theories; obtaining analytic signals of measured waves at one or two wave measuring points according to classification of the wave theories; calculating components occupied by incident waves in disturbance waves based on a first-order diffraction theory and a second-order diffraction theory respectively according to the classification; separating the wavelet signal analytic signals according to a proportion of the components of the incident waves for wavelet inverse transformation, to obtain the near-field incident waves of the fixed offshore engineering structure. The present invention can effectively take into account both computational efficiency and accuracy.

### CROSS REFERENCE TO RELATED APPLICATION

This application claims priority to Chinese Patent Application No. 2023118312524, filed Dec. 27, 2023, the content of which is incorporated herein by reference in its entirety.

### TECHNICAL FIELD

The present disclosure relates to the technical field of offshore engineering, in particular to a method for extracting near-field incident waves of a fixed offshore engineering structure.

### BACKGROUND

As an important structural form in the process of offshore resource development and utilization, fixed offshore engineering structures have been widely used in the field of ocean engineering due to their simple structure, fast construction and relatively low cost. With the increase of the fixed offshore engineering structures that have been built, how to ensure their safe and stable operation during service has received more and more attention from the industry. In order to realize real-time health assessment of the fixed offshore engineering structures, it is necessary to estimate real-time loads acting on the structures by using field-measured data. As an important part of environmental loads acting on the offshore engineering structures, accurate estimation of wave loads is very important. The calculation accuracy of the wave loads mainly depends on the accurate measurement of incident waves acting on the structures. Therefore, how to obtain the incident waves acting on the fixed offshore engineering structures and provide more accurate environmental input conditions for their safe operation and maintenance has great engineering significance for their safe operation.

Wave measurement methods commonly used in the field of offshore engineering mainly include the following two methods: one is to arrange wave buoys far away from the structures, which can directly output wave time courses of wave measuring points, and wave information measured by this method can represent general wave characteristics of this sea area. However, in order to avoid collision damage between the offshore engineering structures and the buoys, generally, it is necessary to arrange the wave buoys at certain distances from the structures, so measured results hardly represent near-field incident waves acting on the structures. The other wave measurement method is to directly measure near-field wave time courses of the structures through wave radar fixed on the offshore engineering structures. Although this method can measure the information of near-field waves acting on the structures, due to large scales of the fixed offshore engineering structures such as mono-pile wind turbines and bridge piers, there is a diffraction effect on wave propagation, resulting in the measured waves, being the superposition of incident wave components and diffraction wave components, forming disturbance wave fields, rather than simple incident waves. At present, no effective method to extract the incident wave components acting on the structures from the near-field disturbance wave fields of fixed offshore engineering structures is available. Therefore, how to invent a method for extracting incident waves of a fixed offshore engineering structure based on the near-field disturbance wave fields of the fixed offshore engineering structures is an urgent problem to be solved in the art.

The existing wave measurement method is to directly measure the near-field wave time courses of the structures by the wave radar fixed to the offshore engineering structures, and approximate them as the incident waves acting on the structures for the calculation of the wave loads. Although this method can measure the information of the near-field waves acting on the structures, due to large scales of the fixed offshore engineering structures such as single pile turbines and bridge piers, there is a diffraction effect on wave propagation, resulting in the measured waves being the superposition of incident wave components and diffraction wave components, forming disturbance wave fields, rather than simple incident waves, so this method cannot obtain accurate incident wave information.

Existing methods for separating incident waves from reflected waves in the field of offshore engineering are mainly used for harbor engineering structures, structural forms of the harbor engineering structures are usually linear (system for separating time domains of incident and reflected waves CN201521144459.5; method for obtaining reflection coefficient of floating breakwater CN202210230173.7), however, the fixed offshore engineering structures such as the single pile turbines and the bridge piers are usually cylindrical, so the existing methods cannot achieve the extraction of the near-field incident waves of the fixed offshore engineering structures.

Therefore, a method for extracting near-field incident waves of a fixed offshore engineering structure is provided.

### SUMMARY

The present disclosure aims at providing a method for extracting near-field incident waves of a fixed offshore engineering structure to solve the problems in the background.

In order to achieve the above objectives, the present disclosure provides the following technical solution: a method for extracting near-field incident waves of a fixed offshore engineering structure includes the following steps:
step 1, calculating a dimensionless wave height parameter and a dimensionless water depth parameter based on measured wave information, and selecting applicable wave theories according to a Meyer's wave classification chart;
step 2, decomposing measured wave signals based on a continuous wavelet transformation theory according to classification of the wave theories provided in step 1, to obtain analytic signals of measured waves at one or two wave measuring points;
step 3, calculating components occupied by incident waves in disturbance waves based on a first-order diffraction theory and a second-order diffraction theory according to the classification in step 1;
step 4, separating the wavelet signal analytic signals in step 2 according to a proportion of the components of the incident waves in step 3 for wavelet inverse transformation, to obtain the near-field incident waves of the fixed offshore engineering structure.

As a preferred implementation of the present disclosure, in step 1:
a wave height H, a water depth d and a cycle T are obtained after statistics according to the measured wave information, and the dimensionless wave height parameter α and the dimensionless water depth parameter β are calculated:

$$α = \frac{H}{{gT}^{2}} \qquad ( 1 )$$

$$β = \frac{d}{{gT}^{2}} \qquad ( 2 )$$

where, g is a gravitational acceleration.

As a preferred embodiment of the present disclosure, according to the classification of the wave theories provided in step 1, when the measured waves are applicable to a linear theory, wave information x_{nA} (t) of one wave measuring point A is required. An analytic signal WTs) of the measured wave can be obtained by decomposing the measured wave signal based on the continuous wavelet transformation theory:

$${WT}_{A} ( s ) = {\sum }_{n = 0}^{N - 1} {x}_{n A} ( t ) {ψ}^{*} ( \frac{( n - {n}^{′} ) δ t}{s} ) \qquad ( 3 )$$

Where, * represents a conjugate complex,
a Morelet's wavelet is selected as a mother wavelet function ψ₀:

$${ψ}_{0} ( t ) = {π}^{- 0.25} {e}^{i {ω}_{0} t} {e}^{- {t}^{2} / 2} \qquad ( 4 )$$

Where, π is a ratio of a circle's circumference to its diameter, e is an exponential function, ω₀ is a center circle frequency, t is time, i is a complex symbol,
a nondimensionalized mother wavelet function ψ is obtained by nondimensionalizing the mother wavelet function ψ₀:

$$ψ ( \frac{( n - {n}^{′} ) δ t}{s} ) = {( \frac{δ t}{s} )}^{0.5} {ψ}_{0} ( \frac{( n - {n}^{′} ) δ t}{s} ) \qquad ( 5 )$$

Where, n′ is a time translation, n is an nth measured wave signal point,
then a group of scale factors s need to be selected in order to complete wavelet transformation:

$${s}_{j} = {s}_{0} {2}^{j δ j} , j = 0 , 1 , 2 , … , J , \qquad ( 6 )$$

Where, sⱼ is a jth scale factor, so is a minimum scale factor, taken as 2δt, and δt is a time step length. δⱼ is a scale parameter, taken as 0.5. J is a maximum scale factor:

$$J = \frac{1}{δ j} {log}_{2} ( \frac{N δ t}{{s}_{0}} ) \qquad ( 7 )$$

Where, N is a length of the measured wave signal.

Each wavelet scale sⱼ corresponds to a circular frequency ωⱼ at the scale under the Morelet's wavelet:

$${ω}_{j} = \frac{{ω}_{0} + {( {ω}_{0}^{2} + 2 )}^{1 / 2}}{2 {s}_{j}} \qquad ( 8 )$$

According to the classification of the wave theories provided in step 1, when the measured waves are applicable to a high-order wave theory, wave information x_{nA} (t) and wave information x_{nB} (t) of two wave measuring points A and B are required. Analytic signals WT_{A}(s) and WT_{B}(s) of the measured waves can be obtained by decomposing the measured wave signals based on the continuous wavelet transformation theory according to a selected mother wavelet function and scale factor:

$${WT}_{A} ( s ) = {\sum }_{n = 0}^{N - 1} {x}_{n 4} ( t ) {ψ}^{*} ( \frac{( n - {n}^{′} ) δ t}{s} ) \qquad ( 9 )$$

$${WT}_{B} ( s ) = {\sum }_{n = 0}^{N - 1} {x}_{n B} ( t ) {ψ}^{*} ( \frac{( n - {n}^{′} ) δ t}{s} ) . \qquad ( 10 )$$

As a preferred implementation of the present disclosure, in step 3:
according to the classification of the wave theories provided in step 1, when the measured waves are applicable to a linear wave theory, a linear measured wave surface η⁽¹⁾ of a near field of the fixed offshore engineering structure can be regarded as superposition of a linear incident wave surface η₁⁽¹⁾ and a linear diffraction wave surface η₁⁽¹⁾ based on a linear diffraction theory:

$${η}^{( 1 )} = {η}_{I}^{( 1 )} + {η}_{D}^{( 1 )} \qquad ( 11 )$$

$$Where ,$$

$${η}_{I}^{( 1 )} = A [ {f}_{0} ( z ) {\sum }_{m = 0}^{∞} {ε}_{m} {i}^{m} {J}_{m} ( {k}_{0} r ) cos m θ ] {e}^{i ω t} \qquad ( 12 )$$

$${η}_{D}^{( 1 )} = - A {f}_{0} ( z ) [ {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ ] {e}^{i ω t} \qquad ( 13 )$$

$$Where , {ε}_{m} = \{ \begin{matrix}1 & m = 0 \\ 2 {i}^{m} & m > 0\end{matrix} \qquad ( 14 )$$

Where, A is a wave amplitude, Jₘ (k₀r) represents an m-order Bessel function of the first kind for k₀r, Hₘ (k₀r) represents an m-order Hankel function of the first kind for k₀r, a first-order wave number k₀ is a positive real root of an equation

$$k tan kd = v , where , v = \frac{{ω}^{2}}{g} ,$$

r represents a distance from a wave measuring point to a circle center of the fixed offshore engineering structure, R represents a radius of the fixed offshore engineering structure, θ represents an incidence angle of the wave, ω represents a circular frequency of the wave, and f₀(z) represents a first-order vertical function:

$${f}_{0} ( z ) = \frac{cosh {k}_{0} ( z + d )}{cosh {k}_{0} d} \qquad ( 15 )$$

Where, z is a vertical position of the wave measuring point, cosh is a hyperbolic cosine function,
a component p₁ occupied by incident waves in a linear measuring wave surface is:

$${p}_{1} = \frac{{η}_{I}^{( 1 )}}{{η}_{I}^{( 1 )} + {η}_{D}^{( 1 )}} = \frac{{\sum }_{m = 0}^{∞} {ε}_{m} {i}^{m} {J}_{m} ( {k}_{0} r ) cos m θ}{{\sum }_{m = 0}^{∞} {ε}_{m} {i}^{m} {J}_{m} ( {k}_{0} r ) cos m θ + {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ} \qquad ( 16 )$$

According to the classification of the wave theories provided in step 1, when the measured waves are applicable to a high-order theory, a high-order measured wave surface η⁽²⁾ of the near field of the fixed offshore engineering structure can be regarded as superposition of a linear incident wave surface η₁⁽¹⁾, a linear diffraction wave surface η_{D}⁽¹⁾, a second-order incident wave surface η₁⁽²⁾ and a second-order diffraction wave surface (2), (2) no based on a second-order diffraction theory:

$${η}^{( 2 )} = {η}_{I}^{( 1 )} + {η}_{D}^{( 1 )} + {η}_{I}^{( 2 )} + {η}_{D}^{( 2 )} \qquad ( 17 )$$

$$Where ,$$

$${η}_{I}^{( 1 )} = \frac{i ω}{g} {φ}_{I}^{( 1 )} {e}^{i ω t} \qquad ( 18 )$$

$${η}_{D}^{( 1 )} = \frac{i ω}{g} {φ}_{D}^{( 1 )} {e}^{i ω t} \qquad ( 19 )$$

$${η}_{I}^{( 2 )} = \frac{2 i ω}{g} {φ}_{I}^{( 2 )} {e}^{2 i ω t} \qquad ( 20 )$$

$${η}_{D}^{( 2 )} = ( \frac{2 i ω}{g} {φ}_{D}^{( 2 )} - \frac{1}{4 g} ∇ {φ}^{( 1 )} \cdot ∇ {φ}^{( 1 )} - \frac{{v}^{2}}{2 g} {φ}^{( 1 )} {φ}^{( 1 )} ) {e}^{2 i ω t} \qquad ( 21 )$$

Where, ∇ is a gradient operator,
a second-order incidence velocity potential φ₁⁽²⁾

$${φ}_{I}^{( 2 )} = - \frac{3 i ω {A}^{2}}{8} \frac{cosh 2 {k}_{0} ( z + d )}{{sinh}^{4} {k}_{0} d} {\sum }_{m = 0}^{∞} {ε}_{m} {i}^{m} {J}_{m} ( 2 {k}_{0} r ) cos m θ \qquad ( 22 )$$

Where, sinh is a hyperbolic sine function, cosh is a hyperbolic cosine function,
a second-order diffraction velocity potential φ_{D}⁽²⁾.

$${φ}_{D}^{( 2 )} = {\sum }_{m = 0}^{∞} {ε}_{m} \{ {f}_{0}^{( 2 )} ( z ) {β}_{m 0} {H}_{m} ( {κ}_{0} r ) + {\sum }_{n = 1}^{∞} {f}_{n}^{( 2 )} ( z ) {β}_{mn} {K}_{m} ( {κ}_{n} r ) + π {iC}_{0} {f}_{0}^{( 2 )} ( z ) {H}_{m} ( {κ}_{0} r ) {\int }_{R}^{r} [ {J}_{m} ( {κ}_{0} ρ ) - \frac{{J}_{m}^{′} ( {κ}_{0} R )}{{H}_{m}^{′} ( {κ}_{0} R )} {H}_{m} ( {κ}_{0} ρ ) ] {Q}_{Dm} ( ρ ) ρ d ρ + 2 {\sum }_{n = 1}^{∞} {C}_{n} {f}_{n}^{( 2 )} ( z ) {K}_{m} ( {κ}_{m} r ) {\int }_{R}^{′} [ {I}_{m} ( {κ}_{n} ρ ) - \frac{{I}_{m}^{′} ( {κ}_{n} R )}{{K}_{m}^{′} ( {κ}_{n} R )} {K}_{m} ( {κ}_{n} ρ ) ] {Q}_{Dm} ( ρ ) ρ d ρ + π {iC}_{0} {f}_{0}^{( 2 )} ( z ) [ {J}_{m} ( {κ}_{0} r ) - \frac{{J}_{m}^{′} ( {κ}_{0} R )}{{H}_{m}^{′} ( {κ}_{0} R )} {H}_{m} ( {κ}_{0} r ) ] {\int }_{r}^{∞} {H}_{m} ( {κ}_{0} ρ ) {Q}_{Dm} ( ρ ) ρ d ρ + 2 {\sum }_{n = 1}^{∞} {C}_{n} {f}_{n}^{( 2 )} ( z ) [ {I}_{m} ( {κ}_{n} r ) - \frac{{I}_{m}^{′} ( {κ}_{n} R )}{{K}_{m}^{′} ( {κ}_{n} R )} {K}_{m} ( {κ}_{n} r ) ] {\int }_{r}^{∞} {K}_{m} ( {κ}_{n} ρ ) {Q}_{Dm} ( ρ ) ρ d ρ \} cos m θ \qquad ( 23 )$$

Where, Kₘ (Kₙr) represents an m-order Bessel function of the second kind with complex argument for Kₙr, Iₘ (Kₙr) represents an m-order Bessel function of the first kind with complex argument for Kₙr, a second-order wave number K₀ is a positive real root of an equation K tan kd=4v, Kₙ is an nth positive real root of an equation ktan kd=−4v, p is a distance from the circle center of the offshore engineering structure to an integration point, ∫₀⁽²⁾ (z) and ∫ₙ⁽²⁾ (z) represent second-order vertical functions:

$${f}_{0}^{( 2 )} ( z ) = \frac{cos {κ}_{0} ( z + d )}{cos {κ}_{0} d} \qquad ( 24 )$$

$${f}_{n}^{( 2 )} ( z ) = \frac{cos {κ}_{n} ( z + d )}{cos {κ}_{n} d} \qquad ( 25 )$$

Coefficients C₀ and Cₙ are as follows:

$${C}_{0} = {[ 2 {\int }_{- d}^{0} {f}_{0}^{( 2 ) 2} ( z ) dz ]}^{- 1} \qquad ( 26 )$$

$${C}_{n} = {[ 2 {\int }_{- d}^{0} {f}_{n}^{( 2 ) 2} ( z ) dz ]}^{- 1} \qquad ( 27 )$$

Coefficients βₘ₀ and βₘₙ are as follows:

$${β}_{m 0} = - \frac{2 {C}_{0}}{{κ}_{0} {H}_{m}^{′} ( {κ}_{0} R ) ( 4 {k}_{0}^{2} - {κ}_{0}^{2} )} \frac{\partial {φ}_{lm}^{( 2 )}}{\partial r} ( R ) \qquad ( 28 )$$

$${β}_{m 0} = - \frac{2 {C}_{n}}{{κ}_{n} {K}_{m}^{′} ( {κ}_{n} R ) ( 4 {k}_{0}^{2} + {κ}_{n}^{2} )} \frac{\partial {φ}_{lm}^{( 2 )}}{\partial r} ( R ) \qquad ( 29 )$$

Where, φ₁ᵢₘ⁽²⁾ (R) is an m-order Fourier component of a second-order incidence potential on a cylindrical wall surface:

$${φ}_{lm}^{( 2 )} ( R ) = \frac{3 i ω {A}^{2}}{2} \frac{v}{{sinh}^{2} {k}_{0} d} {i}^{m} {J}_{m} ( 2 {k}_{0} R ) \qquad ( 30 )$$

Q_{Dm} is an m-order Fourier coefficient of a non-homogeneous term Q_{D} for a free surface:

$${Q}_{D} = \frac{i ω}{2 g} ( 3 {v}^{2} - {k}_{0}^{2} ) ( {φ}_{D}^{{( 1 )}^{2}} + 2 {φ}_{I}^{( 1 )} {φ}_{D}^{( 1 )} ) + \frac{i ω}{g} ( {∇}_{0} {φ}_{D}^{( 1 )} \cdot {∇}_{0} {φ}_{D}^{( 1 )} + 2 {∇}_{0} {φ}_{I}^{( 1 )} \cdot {∇}_{0} {φ}_{D}^{( 1 )} ) \qquad ( 31 )$$

Where, ∇₀ is a horizontal gradient operator,
a first-order incidence velocity potential φ₁⁽¹⁾.

$${φ}_{I}^{( 1 )} = - \frac{igA}{ω} {f}_{0} ( z ) {\sum }_{m = 0}^{∞} {ε}_{m} {i}^{m} {J}_{m} ( {k}_{0} r ) cos m θ \qquad ( 32 )$$

a first-order diffraction velocity potential φ_{D}⁽¹⁾.

$${φ}_{D}^{( 1 )} = \frac{igA}{ω} {f}_{0} ( z ) {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ \qquad ( 33 )$$

a first-order total velocity potential φ⁽¹⁾:

$${φ}^{( 1 )} = \frac{igA}{ω} {f}_{0} ( z ) {\sum }_{m = 0}^{∞} {ε}_{m} {i}^{m} [ - {J}_{m} ( {k}_{0} r ) + \frac{{J}_{m}^{′} ( {k}_{0} R )}{{H}_{m}^{′} ( {k}_{0} R )} {H}_{m} ( {k}_{0} r ) ] cos m θ \qquad ( 34 )$$

Since each component of wavelet transformation in step S2 corresponds to the same circular frequency ω, a second-order wave surface needs to be adjusted, and in the event of ω₂=ω/2 Formula (17) may be written in the following form:

$${{{{η = {η}_{I}^{( 1 )} \vert}_{ω} + {η}_{D}^{( 1 )} \vert}_{ω} + {η}_{I}^{( 2 )} \vert}_{{ω}_{2}} + {η}_{D}^{( 2 )} \vert}_{{ω}_{2}} \qquad ( 35 )$$

Where,

$${{{η}_{I}^{( 1 )} \vert}_{ω} and {η}_{D}^{( 1 )} \vert}_{ω}$$

are linear incidence and diffraction wave surfaces respectively when the circular frequency is ω,

$${{{η}_{I}^{( 2 )} \vert}_{{ω}_{2}} and {η}_{D}^{( 2 )} \vert}_{{ω}_{2}}$$

are second-order incidence and diffraction wave surfaces respectively when the circular frequency is ω₂,
at this moment, since the wave amplitudes are indecomposable, measured wave data of A⁽¹⁾ two wave measuring points is required for inversely deducing a first-order wave amplitude and a second-order wave amplitude A⁽²⁾, the wave amplitude in Formula (35) is independently extracted in order to facilitate description, wave surfaces η_{A} and η_{B} of the two wave measuring points A and B in Formula (35) may be written in the following form:

$${η}_{A} = {A}^{( 1 )} ( \frac{{{{η}_{IA}^{( 1 )} \vert}_{ω} + {η}_{DA}^{( 1 )} \vert}_{ω}}{{A}^{( 1 )}} ) + {A}^{( 2 ) 2} ( \frac{{{{η}_{IA}^{( 2 )} \vert}_{{ω}_{2}} + {η}_{DA}^{( 2 )} \vert}_{{ω}_{2}}}{{A}^{( 2 ) 2}} ) \qquad ( 36 )$$

$${η}_{B} = {A}^{( 1 )} ( \frac{{{{η}_{IB}^{( 1 )} \vert}_{ω} + {η}_{DB}^{( 1 )} \vert}_{ω}}{{A}^{( 1 )}} ) + {A}^{( 2 ) 2} ( \frac{{{{η}_{IB}^{( 2 )} \vert}_{{ω}_{2}} + {η}_{DB}^{( 2 )} \vert}_{{ω}_{2}}}{{A}^{( 2 ) 2}} ) \qquad ( 37 )$$

Where,

$$\frac{{{η}_{IA}^{( 1 )} \vert + {η}_{DA}^{( 1 )} \vert}_{ω}}{{A}^{( 1 )}} and \frac{{{{η}_{IB}^{( 1 )} \vert}_{ω} + {η}_{DB}^{( 1 )} \vert}_{ω}}{{A}^{( 1 )}}$$

can be solved by substituting ω and position information (known conditions) of the wave measuring points A and B into Formula (18) and Formula (19) respectively, and

$$\frac{{{{η}_{IA}^{( 2 )} \vert}_{{ω}_{2}} + {η}_{DA}^{( 2 )} \vert}_{{ω}_{2}}}{{A}^{( 2 ) 2}} and \frac{{{{η}_{IB}^{( 2 )} \vert}_{{ω}_{2}} + {η}_{DB}^{( 2 )} \vert}_{{ω}_{2}}}{{A}^{( 2 ) 2}}$$

can be solved by substituting ω₂ and the position information (known conditions) of the wave measuring (1) NIA points A and B into Formula (20) and Formula (21) respectively. Where,

$${{{η}_{IA}^{( 1 )} \vert}_{ω} and {η}_{IB}^{( 1 )} \vert}_{ω}$$

are linear incidence wave surfaces of the wave measuring points A and B respectively when the circular frequency is

$${{{η}_{DA}^{( 1 )} \vert}_{ω} and {η}_{DB}^{( 1 )} \vert}_{ω}$$

are linear diffraction wave surfaces of the wave measuring points A and B respectively when the circular frequency is ω,

$${{{η}_{IA}^{( 2 )} \vert}_{{ω}_{2}} and {η}_{IB}^{( 2 )} \vert}_{{ω}_{2}}$$

are second-order incidence wave surfaces of the wave measuring points A and B respectively when the circular frequency is ω₂,

$${η}_{DA}^{( 2 )} {\vert}_{{ω}_{2}} and {η}_{DB}^{( 2 )} {\vert}_{{ω}_{2}}$$

are second-order diffraction wave surfaces of the wave measuring points A and B respectively when the circular frequency is ω₂,
and meanwhile, wave surface information of right sides of Formula (36) and Formula (37) can be obtained through wavelet decomposition, namely, the analytical signals WT_{A}(s) and WT_{B}(s) of the measured waves in Formula (9) and Formula (10). The first-order wave amplitude A⁽¹⁾ and the second-order wave amplitude A⁽²⁾ can be obtained by solving the simultaneous equations (36) and (37), and
a component p₂ occupied by incident waves in a second-order measuring wave surface is:

$${p}_{2} = \frac{{η}_{IA}^{( 1 )} {\vert}_{ω} + {η}_{IA}^{( 2 )} {\vert}_{ω}}{{η}_{IA}^{( 1 )} {\vert}_{ω} + {η}_{D A}^{( 1 )} {\vert}_{ω} + {η}_{IA}^{( 2 )} {\vert}_{{ω}_{2}} + {η}_{D A}^{( 2 )} {\vert}_{{ω}_{2}}} . \qquad ( 38 )$$

As a preferred implementation of the present disclosure, in step 4:
according to the classification of the wave theories provided in step 1, when the measured waves are applicable to a linear wave theory, the analytical signal WT_{A}(s) of the measured wave in step 4 is shown in Formula (8), a component p₁ occupied by incident waves in a linear measuring wave surface is shown in Formula (16), and an analytical signal WT₁⁽¹⁾(s) of the incident waves may be obtained by multiplying both of the above:

$${WT}_{I}^{( 1 )} ( s ) = {p}_{1} {WT}_{A} ( s ) \qquad ( 37 )$$

An analytical signal WT₁⁽¹⁾(sⱼ) of a linear incident wave corresponding to each wavelet scale sⱼ is as follows:

$${WT}_{I}^{( 1 )} ( {s}_{j} ) = {p}_{j 1} {WT}_{A} ( {s}_{j} ) \qquad ( 38 )$$

Where, pⱼ₁ is a component occupied by incident waves in the linear measuring wave surface corresponding to each wavelet scale sⱼ:

$${p}_{j 1} = \frac{{\sum }_{m = 0}^{∞} {ε}_{m} {i}^{m} {J}_{m} ( {k}_{0 j} r ) cos m θ}{{\sum }_{m = 0}^{∞} {ε}_{m} {i}^{m} {J}_{m} ( {k}_{{0}_{j}} r ) cos m θ + {\sum }_{m = 0}^{∞} {ε}_{m} {i}^{m} \frac{{J}_{m}^{′} ( {k}_{0 j} R )}{{H}_{m}^{′} ( {k}_{0 j} R )} {H}_{m} ( {k}_{0 j} r ) cos m θ} \qquad ( 39 )$$

A circular frequency ωⱼ corresponding to each wavelet scale sⱼ can be obtained by Formula (8), and a wave number k₀ⱼ corresponding to each wavelet scale sⱼ in Formula (39) can be obtained according to a dispersion relationship under a limited water depth:

$${k}_{j} = \frac{{ω}_{j}}{{( g d )}^{1 / 2}} = \frac{{ω}_{0} + {( {ω}_{0}^{2} + 2 )}^{1 / 2}}{2 {{s}_{j} ( g d )}^{1 / 2}} \qquad ( 40 )$$

The analytical signal x₁⁽¹⁾(t) of the linear incident wave can be obtained by performing wavelet inverse transformation on WT₁⁽¹⁾(sⱼ).

$${x}_{I}^{( 1 )} ( t ) = \frac{δ j δ {t}^{1 / 2}}{{C}_{δ} {ψ}_{0} ( 0 )} {\sum }_{j = 0}^{J} \frac{{WT}_{I}^{( 1 )} ( {s}_{j} )}{{s}_{j}^{1 / 2}} \qquad ( 41 )$$

According to the classification of the wave theories provided in step 1, when the measured waves are applicable to a high-order wave theory, the analytical signal WT_{A}(s) of the measured wave in step S4 is shown in Formula (9), a component p₂ occupied by incident waves in a high-order measuring wave surface is shown in Formula (36), and an analytical signal WT₁⁽²⁾(s) of the high-order incident waves may be obtained by multiplying both of the above:

$${WT}_{I}^{( 2 )} ( s ) = {p}_{2} {WT}_{A} ( s ) \qquad ( 42 )$$

An analytical signal WT₁⁽²⁾(sⱼ) of a high-order incident wave corresponding to each wavelet scale sⱼ is as follows:

$${WT}_{I}^{( 2 )} ( {s}_{j} ) = {p}_{j 2} W {T}_{A} ( {s}_{j} ) \qquad ( 43 )$$

Where, pⱼ₂ is a component occupied by incident waves in the high-order measuring wave surface corresponding to each wavelet scale sⱼ, which is obtained by substituting the circular frequency ωⱼ corresponding to each wavelet scale sⱼ obtained by Formula (8) into Formula (36):

$${p}_{j 2} = \frac{{η}_{IA}^{( 1 )} {\vert}_{{ω}_{j}} + {η}_{IA}^{( 2 )} {\vert}_{{ω}_{j}}}{{η}_{IA}^{( 1 )} {\vert}_{{ω}_{j}} + {η}_{D A}^{( 1 )} {\vert}_{{ω}_{j}} + {η}_{IA}^{( 2 )} {\vert}_{{ω}_{j 2}} + {η}_{D A}^{( 2 )} {\vert}_{{ω}_{j 2}}} \qquad ( 44 )$$

$$Where , {ω}_{j 2} = {ω}_{j} / 2 ,$$

A time series x₁²(t) of the high-order incident waves can be obtained by performing wavelet inverse transformation on WT₁⁽²⁾(sⱼ).

$${x}_{I}^{( 2 )} ( t ) = \frac{δ j δ {t}^{1 / 2}}{{C}_{δ} {ψ}_{0} ( 0 )} {\sum }_{j = 0}^{J} \frac{{WT}_{I}^{( 2 )} ( {s}_{j} )}{{s}_{j}^{1 / 2}} . \qquad ( 45 )$$

Compared with the prior art, the present disclosure has the following beneficial effects:

In the present disclosure, before the incident waves are extracted, the measured waves are classified by referring to the Meyer's wave classification chart according to the dimensionless wave height parameter and the dimensionless water depth parameter, and when the measured waves are applicable to the linear theory, they are separated based on the linear diffraction theory; when the measured waves are suitable for the high-order wave theory, they are separated based on the second-order diffraction theory in order to improve calculation efficiency; and this classification method can provide a basis for selecting diffraction theories during subsequent extraction of the incident waves, not only redundant calculation caused by adopting the high-order theory for linear waves is avoided, but also accuracy reduction caused by adopting the linear theory for high-order waves is avoided, thereby effectively taking calculation efficiency and calculation accuracy into account.

On the basis of the classification of the wave theories, the measured wave signals are decomposed based on the continuous wavelet transformation theory, to obtain the analytical signals of the measured waves, and non-stability of random waves can be effectively considered by time-frequency characteristics of wavelet transformation. When the measured waves are applicable to the linear wave theory, the analytical signal of one wave measuring point is established; when the measured waves are applicable to the high-order wave theory, the analytical signals of two wave measuring points are established in order to improve calculation efficiency; and this method for establishing the analytical signals can effectively control the number of wave measuring points on the premise of ensuring calculation accuracy, thereby avoiding the situation that calculation efficiency is reduced due to redundant data participating in calculation.

The components occupied by the incident wave components in the linear measured waves and the high-order measured waves are provided based on the linear diffraction rule and the second-order diffraction rule respectively, compared with an existing method, the diffraction theories adopted in the present disclosure are more applicable to cylindrical fixed offshore engineering structures such as single pile turbines and bridge piers, especially, the second-order wave surface is adjusted by considering that each component of wavelet transformation corresponds to the same circular frequency in the process of decomposing the high-order measured waves, a method for representing the component occupied by the incident wave components in the analytical signal of the measured wave corresponding to each wavelet scale in the high-order waves is provided, and the first-order wave amplitude and the second-order wave amplitude are inversely deduced through the measured wave data of the two wave measuring points, thereby solving the problem that the wave amplitudes are indecomposable in the process of extracting the high-order incident waves.

The analytical signal of the linear incident wave or the high-order incident wave corresponding to each wavelet scale is obtained by multiplying the analytical signal of the linear measured wave or the high-order measured wave corresponding to each wavelet scale obtained through wavelet transformation by the component occupied by the incident waves, and the time series of the linear or high-order incident waves can be obtained by performing wavelet inverse transformation on this group of analytical signals, thereby achieving the extraction of the near-field incident waves of the fixed offshore engineering structure on time domains.

### BRIEF DESCRIPTION OF THE DRAWINGS

By reading the detailed descriptions made to the nonrestrictive embodiments with reference to the following drawings, other characteristics, purposes and advantages of the present disclosure will be clear:

FIG. 1 is a schematic diagram of waves of a near-field sea area of an offshore wind turbine according to a method for extracting near-field incident waves of a fixed offshore engineering structure of the present disclosure;

FIG. 2 is a comparison diagram of an estimated incident wave and a real incident wave according to a method for extracting near-field incident waves of a fixed offshore engineering structure of the present disclosure; and

FIG. 3 is a parameter diagram of offshore wind turbines and incident waves thereof in a near-field sea area according to a method for extracting near-field incident waves of a fixed offshore engineering structure of the present disclosure.

### DETAILED DESCRIPTION OF THE EMBODIMENTS

The present disclosure is further described with reference to specific implementations to have a clear understanding of the technical means, creative features, achieved objectives and effects embodied therein.

### EMBODIMENT

The embodiment is a method for extracting near-field incident waves of a fixed offshore engineering structure, including the following specific steps:

S1, wave information x_{nA} (t) of near-field waves of the structure at a certain position (denoted as wave measuring point A) is obtained by wave measuring equipment installed on the fixed offshore engineering structure, wherein, t is time.

S2, a wave height H, a water depth d and a cycle T are obtained after mathematical statistics according to the measured wave information x_{nA} (t) at the wave measuring point A, and a dimensionless wave height parameter α and a dimensionless water depth parameter β are calculated;

$$α = \frac{H}{{gT}^{2}} \qquad ( 1 )$$

$$β = \frac{d}{{gT}^{2}} \qquad ( 2 )$$

where, g is a gravitational acceleration.

Applicable wave theories are selected by searching in a Meyer's wave classification chart according to the dimensionless wave height parameter α and the dimensionless water depth parameter β. When measured waves are applicable to a linear theory, they are separated based on a linear diffraction theory, and it proceeds to steps S3 to S5; and when the measured waves are applicable to a high-order wave theory, they are separated based on a second-order diffraction theory in order to improve calculation efficiency, and it proceeds to steps S6 to S8.

S3, according to classification of the wave theories provided in step S1, when the measured waves are applicable to the linear theory, wave information x_{nA} (t) of one wave measuring point A is required, a measured wave signal is decomposed based on a continuous wavelet transformation theory, and then an analytical signal WT_{A}(s) of the measured wave can be obtained:

$${WT}_{A} ( s ) = {\sum }_{n = 0}^{N - 1} {x}_{n A} ( t ) ψ * ( \frac{( n - {n}^{′} ) δ t}{s} ) \qquad ( 3 )$$

where, * represents a conjugate complex.

A Morelet's wavelet is selected as a mother wavelet function ψ₀:

$${ψ}_{0} ( t ) = {π}^{- 0.25} {e}^{i {ω}_{0} t} {e}^{- {t}^{2} / 2} \qquad ( 4 )$$

where, π is a ratio of a circle's circumference to its diameter, e is an exponential function, ω₀ is a center circle frequency, t is time, and i is a complex symbol.

A nondimensionalized generating wavelet t function ψ is obtained by nondimensionalizing the mother wavelet function ψ₀:

$$ψ ( \frac{( n - {n}^{′} ) δ t}{s} ) = {( \frac{δ t}{s} )}^{0.5} {ψ}_{0} ( \frac{( n - {n}^{′} ) δ t}{s} ) \qquad ( 5 )$$

where, n′ is a time translation, and n is an nth measured wave signal point.

Then a group of scale factors s are selected:

$${s}_{j} = {s}_{0} {2}^{j δ j} , j = 0 , 1 , 2 , … , J , \qquad ( 6 )$$

where, sⱼ is a jth scale factor, so is a minimum scale factor, taken as 2δt, and δt is a time step length. δj is a scale parameter, taken as 0.5. J is a maximum scale factor:

$$J = \frac{1}{δ j} {log}_{2} ( \frac{N δ t}{{s}_{0}} ) \qquad ( 7 )$$

where, N is a length of the measured wave signal.

Each wavelet scale sⱼ corresponds to a circular frequency ωⱼ at the scale under the Morelet's wavelet:

$${ω}_{j} = \frac{{ω}_{0} + {( {ω}_{0}^{2} + 2 )}^{1 / 2}}{2 {s}_{j}} \qquad ( 8 )$$

S4, when the measured wave is applicable to the linear wave theory, a linear measured wave surface η⁽¹⁾ of a near field of the fixed offshore engineering structure is written as superposition of a linear incident wave surface η⁽¹⁾ and a linear diffraction wave surface η_{D}⁽¹⁾ based on a linear diffraction theory:

$${η}^{( 1 )} = {η}_{I}^{( 1 )} + {η}_{D}^{( 1 )} \qquad ( 9 )$$

$$Where ,$$

$${η}_{I}^{( 1 )} = A [ {f}_{0} ( z ) {\sum }_{m = 0}^{∞} {ε}_{m} {i}^{m} {J}_{m} ( {k}_{0} r ) cos m θ ] {e}^{i ω t} \qquad ( 10 )$$

$${η}_{D}^{( 1 )} = - {Af}_{0} ( z ) [ {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ ] {e}^{i ω t} \qquad ( 11 )$$

$$Where ,$$

$${ε}_{m} = \{ \begin{matrix}1 & m = 0 \\ 2 {i}^{m} & m > 0\end{matrix} \qquad ( 12 )$$

where, A is a wave amplitude, Jₘ (k₀r) represents an m-order Bessel function of the first kind for k₀r, Hₘ (k₀r) represents an m-order Hankel function of the first kind for k₀r, a first-order wave number k₀ is a positive real root of an equation k tan kd=v, where, v=φ²/g, r represents a distance from a wave measuring point to a circle center of the fixed offshore engineering structure, R represents a radius of the fixed offshore engineering structure, θ represents an incidence angle of the wave, ω represents a circular frequency of the wave, and f₀(z) represents a first-order vertical function:

$${f}_{0} ( z ) = \frac{cosh {k}_{0} ( z + d )}{cosh {k}_{0} d} \qquad ( 13 )$$

where, z is a vertical position of the wave measuring point, and cosh is a hyperbolic cosine function.

A component p₁ occupied by incident waves in the linear measuring wave surface is:

$${p}_{1} = \frac{{η}_{I}^{( 1 )}}{{η}_{I}^{( 1 )} + {η}_{D}^{( 1 )}} = \frac{{\sum }_{m = 0}^{∞} {ε}_{m} {i}^{m} {J}_{m} ( {k}_{0} r ) cos m θ}{{\sum }_{m = 0}^{∞} {ε}_{m} {i}^{m} {J}_{m} ( {k}_{0} r ) cos m θ + {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ} \qquad ( 14 )$$

S5, when the measured wave is applicable to the linear wave theory, an analytical signal WT_{A}(s) of the measured wave is shown in Formula (3), a component p₁ occupied by the incident waves in the linear measuring wave surface is shown in Formula (14), and an analytical signal WT₁⁽¹⁾ (s) of the incident waves may be obtained by multiplying both of the above:

$${WT}_{I}^{( 1 )} ( s ) = {p}_{1} {WT}_{A} ( s ) \qquad ( 15 )$$

An analytical signal WT₁⁽¹⁾(sⱼ) of a linear incident wave corresponding to each wavelet scale sⱼ, at the wave measuring point A is as follows:

$${WT}_{I}^{( 1 )} ( {s}_{j} ) = {p}_{j 1} {WT}_{A} ( {s}_{j} ) \qquad ( 16 )$$

Where, pⱼ₁ is a component occupied by incident waves in the linear measuring wave surface corresponding to each wavelet scale sⱼ, which can be obtained by Formula (14):

$${p}_{j 1} = \frac{{\sum }_{m = 0}^{∞} {ε}_{m} {i}^{m} {J}_{m} ( {k}_{0 j} r ) cos m θ}{{\sum }_{m = 0}^{∞} {ε}_{m} {i}^{m} {J}_{m} ( {k}_{0 j} r ) cos m θ + {\sum }_{m = 0}^{∞} {ε}_{m} {i}^{m} \frac{{J}_{m}^{′} ( {k}_{0 j} R )}{{H}_{m}^{′} ( {k}_{0 j} R )} {H}_{m} ( {k}_{0 j} r ) cos m θ} \qquad ( 17 )$$

A circular frequency ωⱼ corresponding to each wavelet scale sⱼ can be obtained by Formula (8), and a wave number k₀ⱼ corresponding to each wavelet scale sⱼ in Formula (14) can be obtained according to a dispersion relationship under a limited water depth:

$${k}_{j} = \frac{{ω}_{j}}{{( gd )}^{1 / 2}} = \frac{{ω}_{0} + {( {ω}_{0}^{2} + 2 )}^{1 / 2}}{2 {{s}_{j} ( gd )}^{1 / 2}} \qquad ( 18 )$$

The analytical signal x₁⁽¹⁾(t) of the linear incident wave can be obtained by performing wavelet inverse transformation on WT₁⁽¹⁾ (sⱼ).

$${x}_{I}^{( 1 )} ( t ) = \frac{δ j δ {t}^{1 / 2}}{{C}_{δ} {ψ}_{0} ( 0 )} {\sum }_{j = 0}^{J} \frac{{WT}_{I}^{( 1 )} ( {s}_{j} )}{{{s}_{j}}^{1 / 2}} \qquad ( 19 )$$

S6, according to the classification of the wave theories provided in step 2, when the measured wave is applicable to the high-order wave theory, wave information x_{nA} (t) and wave information x_{nB} (t) of two wave measuring points A and B are required. Analytic signals WT_{A}(s) and WT_{B}(s) of the measured wave can be obtained by decomposing the measured wave signals based on the continuous wavelet transformation theory according to a selected mother wavelet function and scale factor:

$${WT}_{A} ( s ) = {\sum }_{n = 0}^{N - 1} {x}_{nA} ( t ) {ψ}^{*} ( \frac{( n - {n}^{′} ) δ t}{s} ) \qquad ( 20 )$$

$${WT}_{B} ( s ) = {\sum }_{n = 0}^{N - 1} {x}_{nB} ( t ) {ψ}^{*} ( \frac{( n - {n}^{′} ) δ t}{s} ) \qquad ( 21 )$$

Where, each variable can be calculated by Formula (4) to Formula (8).

S7, when the measured wave is applicable to the high-order theory, a high-order, measured wave surface η⁽²⁾ of the near field of the fixed offshore engineering structure can be regarded as superposition of a linear incident wave surface η₁⁽¹⁾, a linear diffraction wave surface η_{D}⁽¹⁾, a second-order incident wave surface η₁⁽²⁾ and a second-order diffraction wave surface η_{D}⁽²⁾ based on a second-order diffraction theory:

$${η}^{( 2 )} = {η}_{I}^{( 1 )} + {η}_{D}^{( 1 )} + {η}_{I}^{( 2 )} + {η}_{D}^{( 2 )} \qquad ( 22 )$$

$$Where ,$$

$${η}_{I}^{( 1 )} = \frac{i ω}{g} {φ}_{I}^{( 1 )} {e}^{i ω t} \qquad ( 23 )$$

$${η}_{D}^{( 1 )} = \frac{i ω}{g} {φ}_{D}^{( 1 )} {e}^{i ω t} \qquad ( 24 )$$

$${η}_{I}^{( 2 )} = \frac{2 i ω}{g} {φ}_{I}^{( 2 )} {e}^{2 i ω t} \qquad ( 25 )$$

$${η}_{D}^{( 2 )} = ( \frac{2 i ω}{g} {φ}_{D}^{( 2 )} - \frac{1}{4 g} ∇ {φ}^{( 1 )} \cdot ∇ {φ}^{( 1 )} - \frac{{v}^{2}}{2 g} {φ}^{( 1 )} {φ}^{( 1 )} ) {e}^{2 i ω t} \qquad ( 26 )$$

Where, ∇ is a gradient operator;
a second-order incidence velocity potential φ₁⁽²⁾

$${φ}_{I}^{( 2 )} = - \frac{3 i ω {A}^{2}}{8} \frac{cosh 2 {k}_{0} ( z + d )}{{sinh}^{4} {k}_{0} d} {\sum }_{m = 0}^{∞} {ε}_{m} {i}^{m} {J}_{m} ( 2 {k}_{0} r ) cos m θ \qquad ( 27 )$$

Where, sinh is a hyperbolic sine function, and cosh is a hyperbolic cosine function;
a second-order diffraction velocity potential φ_{D}⁽²⁾;

$${φ}_{D}^{( 2 )} = {\sum }_{m = 0}^{∞} {ε}_{m} \{ {f}_{0}^{( 2 )} ( z ) {β}_{m 0} {H}_{m} ( {κ}_{0} r ) + {\sum }_{n = 1}^{∞} {f}_{n}^{( 2 )} ( z ) {β}_{mn} {K}_{m} ( {κ}_{n} r ) + π {iC}_{0} {f}_{0}^{( 2 )} ( z ) {H}_{m} ( {κ}_{0} r ) {\int }_{R}^{r} [ {J}_{m} ( {κ}_{0} ρ ) - \frac{{J}_{m}^{′} ( {κ}_{0} R )}{{H}_{m}^{′} ( {κ}_{0} R )} {H}_{m} ( {κ}_{0} ρ ) ] {Q}_{Dm} ( ρ ) ρ d ρ + 2 {\sum }_{n = 1}^{∞} {C}_{n} {f}_{n}^{( 2 )} ( z ) {K}_{m} ( {κ}_{m} r ) {\int }_{R}^{r} [ {I}_{m} ( {κ}_{n} ρ ) - \frac{{I}_{m}^{′} ( {κ}_{n} R )}{{K}_{m}^{′} ( {κ}_{n} R )} {K}_{m} ( {κ}_{n} ρ ) ] {Q}_{Dm} ( ρ ) ρ d ρ + π {iC}_{0} {f}_{0}^{( 2 )} ( z ) [ {J}_{m} ( {κ}_{0} r ) - \frac{{J}_{m}^{′} ( {κ}_{0} R )}{{H}_{m}^{′} ( {κ}_{0} R )} {H}_{m} ( {κ}_{0} r ) ] {\int }_{r}^{∞} {H}_{m} ( {κ}_{0} ρ ) {Q}_{Dm} ( ρ ) ρ d ρ + 2 {\sum }_{n = 1}^{∞} {C}_{n} {f}_{n}^{( 2 )} ( z ) [ {I}_{m} ( {κ}_{n} r ) - \frac{{I}_{m}^{′} ( {κ}_{n} R )}{{K}_{m}^{′} ( {κ}_{n} R )} {K}_{m} ( {κ}_{n} r ) ] {\int }_{r}^{∞} {K}_{m} ( {κ}_{n} ρ ) {Q}_{Dm} ( ρ ) ρ d ρ \} cos m θ \qquad ( 28 )$$

Where, Kₘ (Kₙr) represents an m-order Bessel function of the second kind with complex argument for Kₙr, Iₘ (Kₙr) represents an m-order Bessel function of the first kind with complex argument for Kₙr, a second-order wave number K₀ is a positive real root of an equation Ktankd=4v, Kₙ is an nth positive real root of an equation Ktankd=−4v, and p is a distance from the circle center of the offshore engineering structure to an integration point;

f₀⁽²⁾ (z) and fₙ⁽²⁾ (z) represent second-order vertical functions:

$${f}_{0}^{( 2 )} ( z ) = \frac{cos {κ}_{0} ( z + d )}{cos {κ}_{0} d} \qquad ( 29 )$$

$${f}_{n}^{( 2 )} ( z ) = \frac{cos {κ}_{n} ( z + d )}{cos {κ}_{n} d} \qquad ( 30 )$$

Coefficients C₀ and Cₙ are as follows:

$${C}_{0} = {[ 2 {\int }_{- d}^{0} {f}_{0}^{( 2 ) 2} ( z ) dz ]}^{- 1} \qquad ( 31 )$$

$${C}_{n} = {[ 2 {\int }_{- d}^{0} {f}_{n}^{( 2 ) 2} ( z ) dz ]}^{- 1} \qquad ( 32 )$$

Coefficients βₘ₀ and βₘₙ are as follows:

$${β}_{m 0} = - \frac{2 {C}_{0}}{{κ}_{0} {H}_{m}^{′} ( {κ}_{0} R ) ( 4 {k}_{0}^{2} - {κ}_{0}^{2} )} \frac{\partial {φ}_{Im}^{( 2 )}}{\partial r} ( R ) \qquad ( 33 )$$

$${β}_{m 0} = - \frac{2 {C}_{n}}{{κ}_{n} {K}_{m}^{′} ( {κ}_{n} R ) ( 4 {k}_{0}^{2} - {κ}_{n}^{2} )} \frac{\partial {φ}_{Im}^{( 2 )}}{\partial r} ( R ) \qquad ( 34 )$$

Where, φ₁ₘ⁽²⁾(R) is an m-order Fourier component of a second-order incidence potential on a cylindrical wall surface:

$${φ}_{Im}^{( 2 )} ( R ) = \frac{3 i ω {A}^{2}}{2} \frac{v}{{sinh}^{2} {k}_{0} d} {i}^{m} {J}_{m} ( 2 {k}_{0} R ) \qquad ( 35 )$$

Q_{Dm} is an m-order Fourier coefficient of a non-homogeneous term Q_{D} for a free surface:

$${Q}_{D} = \frac{i ω}{2 g} ( 3 {v}^{2} - {k}_{0}^{2} ) ( {φ}_{D}^{{( 1 )}^{2}} + 2 {φ}_{I}^{( 1 )} {φ}_{D}^{( 1 )} ) + \frac{i ω}{g} ( {∇}_{0} {φ}_{D}^{( 1 )} \cdot {∇}_{0} {φ}_{D}^{( 1 )} + 2 {∇}_{0} {φ}_{I}^{( 1 )} \cdot {∇}_{0} {φ}_{D}^{( 1 )} ) \qquad ( 36 )$$

Where, ∇₀ is a horizontal gradient operator;
a first-order incidence velocity potential φ₁⁽¹⁾;

$${φ}_{I}^{( 1 )} = - \frac{igA}{ω} {f}_{0} ( z ) {\sum }_{m = 0}^{∞} {ε}_{m} {i}^{m} {J}_{m} ( {k}_{0} r ) cos m θ \qquad ( 37 )$$

a first-order diffraction velocity potential φ_{D}⁽¹⁾

$${φ}_{I}^{( 1 )} = \frac{igA}{ω} {f}_{0} ( z ) {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ \qquad ( 38 )$$

a first-order total velocity potential φ⁽¹⁾:

$${φ}^{( 1 )} = \frac{igA}{ω} {f}_{0} ( z ) {\sum }_{m = 0}^{∞} {ε}_{m} {i}^{m} [ - {J}_{m} ( {k}_{0} r ) + \frac{{J}_{m}^{′} ( {k}_{0} R )}{{H}_{m}^{′} ( {k}_{0} R )} {H}_{m} ( {k}_{0} r ) ] cos m θ \qquad ( 39 )$$

Since each component of wavelet transformation in step S2 corresponds to the same circular frequency ω, a second-order wave surface needs to be adjusted, and in the event of ω₂=ω/2 Formula (22) may be written in the following form:

$${{η = {η}_{I}^{( 1 )} {\vert}_{ω} + {η}_{D}^{( 1 )} \vert}_{ω} + {η}_{I}^{( 2 )} {\vert}_{{ω}_{2}} + {η}_{D}^{( 2 )} \vert}_{{ω}_{2}} \qquad ( 40 )$$

Where,

$${{{η}_{I}^{( 1 )} \vert}_{ω} and {η}_{D}^{( 1 )} \vert}_{ω}$$

are linear incidence and diffraction wave surfaces respectively when the circular frequency is ω, and

$${{η}_{I}^{( 2 )} {\vert}_{{ω}_{2}} and {η}_{D}^{( 2 )} \vert}_{{ω}_{2}}$$

are second-order incidence and diffraction wave surfaces respectively when the circular frequency is ω₂.

At this moment, since the wave amplitudes are indecomposable, measured wave data of two wave measuring points is required for inversely deducing a first-order wave amplitude A⁽¹⁾ and a second-order wave amplitude A⁽²⁾. The wave amplitudes in Formula (40) are independently extracted in order to facilitate description, and wave surfaces η_{A} and η_{B} of the two wave measuring points A and B in Formula (40) may be written in the following form:

$${η}_{A} = {A}^{( 1 )} ( \frac{{{η}_{IA}^{( 1 )} {\vert}_{ω} + {η}_{DA}^{( 1 )} \vert}_{ω}}{{A}^{( 1 )}} ) + {A}^{( 2 ) 2} ( \frac{{{η}_{IA}^{( 2 )} {\vert}_{{ω}_{2}} + {η}_{DA}^{( 2 )} \vert}_{{ω}_{2}}}{{A}^{( 2 ) 2}} ) \qquad ( 41 )$$

$${η}_{B} = {A}^{( 1 )} ( \frac{{{η}_{IB}^{( 1 )} {\vert}_{ω} + {η}_{DB}^{( 1 )} \vert}_{ω}}{{A}^{( 1 )}} ) + {A}^{( 2 ) 2} ( \frac{{{η}_{IB}^{( 2 )} {\vert}_{{ω}_{2}} + {η}_{DB}^{( 2 )} \vert}_{{ω}_{2}}}{{A}^{( 2 ) 2}} ) \qquad ( 42 )$$

Where,

$$\frac{{{η}_{IA}^{( 1 )} {\vert}_{ω} + {η}_{DA}^{( 1 )} \vert}_{ω}}{{A}^{( 1 )}} and \frac{{{η}_{IB}^{( 1 )} {\vert}_{ω} + {η}_{DB}^{( 1 )} \vert}_{ω}}{{A}^{( 1 )}}$$

can be solved by substituting w and position information (known conditions) of the wave measuring points A and B into Formula (23) and Formula (24) respectively, and

$$\frac{{{η}_{IA}^{( 2 )} {\vert}_{{ω}_{2}} + {η}_{DA}^{( 2 )} \vert}_{{ω}_{2}}}{{A}^{( 2 ) 2}} and \frac{{{η}_{IB}^{( 2 )} {\vert}_{{ω}_{2}} + {η}_{DB}^{( 2 )} \vert}_{{ω}_{2}}}{{A}^{( 2 ) 2}}$$

can be solved by substituting ω₂ and the position information (known conditions) of the wave measuring (1) NIB points A and B into Formula (25) and Formula (26) respectively. Where,

$${{{η}_{IA}^{( 1 )} \vert}_{ω} and {η}_{IB}^{( 1 )} \vert}_{ω}$$

are linear incidence wave surfaces of the wave measuring points A and B respectively when the circular frequency is ω,

$${{{η}_{DA}^{( 1 )} \vert}_{ω} and {η}_{DB}^{( 1 )} \vert}_{ω}$$

are linear diffraction wave surfaces of the wave measuring points A and B respectively when the circular frequency is ω,

$${η}_{IA}^{( 2 )} {\vert}_{{ω}_{2}} and {η}_{IB}^{( 2 )} {\vert}_{{ω}_{2}}$$

are second-order incidence wave surfaces of the wave measuring points A and B respectively when the circular frequency is ω₂, and

$${{{η}_{DA}^{( 2 )} \vert}_{{ω}_{2}} and {η}_{DB}^{( 2 )} \vert}_{{ω}_{2}}$$

are second-order diffraction wave surfaces of the wave measuring points A and B respectively when the circular frequency is ω₂.

Meanwhile, wave surface information of right sides of Formula (41) and Formula (42) can be obtained through wavelet decomposition, namely, the analytical signals WT_{A}(s) and WT_{B}(s) of the measured waves in Formula (20) and Formula (21). The first-order wave amplitude A⁽¹⁾ and the second-order wave amplitude A⁽²⁾ can be obtained by solving the simultaneous equations (41) and (42).

A component p₂ occupied by incident waves in a second-order measuring wave surface is:

$${p}_{2} = \frac{{η}_{IA}^{( 1 )} {\vert}_{ω} + {η}_{IA}^{( 2 )} {\vert}_{ω}}{{η}_{IA}^{( 1 )} {\vert}_{ω} + {η}_{D A}^{( 1 )} {\vert}_{ω} + {η}_{IA}^{( 2 )} {\vert}_{ω 2} + {η}_{D A}^{( 2 )} {\vert}_{ω 2}} \qquad ( 43 )$$

S8, when the measured wave is applicable to the high-order wave theory, the analytical signal WT_{A}(s) of the measured wave in step S6 is shown in Formula (20), a component p₂ occupied by incident waves in a high-order measuring wave surface is shown in Formula (43), and an analytical signal WT₁⁽²⁾ (s) of the high-order incident waves may be obtained by multiplying both of the above:

$${WT}_{I}^{( 2 )} ( s ) = {p}_{2} {WT}_{A} ( s ) \qquad ( 44 )$$

An analytical signal WT₁⁽²⁾(sⱼ) of a high-order incident wave corresponding to each wavelet scale sⱼ is as follows:

$${WT}_{I}^{( 2 )} ( {s}_{j} ) = {p}_{j 2} W {T}_{A} ( {s}_{j} ) \qquad ( 45 )$$

Where, pⱼ₂ is a component occupied by incident waves in the high-order measuring wave surface corresponding to each wavelet scale sⱼ, which is obtained by substituting the circular frequency @j corresponding to each wavelet scale sⱼ obtained by Formula (8) into Formula (43):

$${p}_{j 2} = \frac{{η}_{IA}^{( 1 )} {\vert}_{{ω}_{j}} + {η}_{IA}^{( 2 )} {\vert}_{{ω}_{j}}}{{η}_{IA}^{( 1 )} {{\vert}_{ω}}_{j} + {η}_{D A}^{( 1 )} {\vert}_{{ω}_{j}} + {η}_{IA}^{( 2 )} {\vert}_{{ω}_{j 2}} + {η}_{D A}^{( 2 )} {\vert}_{{ω}_{j 2}}} \qquad ( 46 )$$

$$Where , {ω}_{j 2} = {ω}_{j} / 2 ;$$

A time series x₁⁽²⁾(t) of the high-order incident waves can be obtained by performing wavelet inverse transformation on WT₁⁽²⁾(sⱼ).

$${x}_{I}^{( 2 )} ( t ) = \frac{δ j δ {t}^{1 / 2}}{{C}_{δ} {ψ}_{0} ( 0 )} {\sum }_{j = 0}^{J} \frac{{WT}_{I}^{( 2 )} ( {s}_{j} )}{{s}_{j}^{1 / 2}} \qquad ( 47 )$$

A specific example is taken for illumination, incident waves of a near-field sea area of an offshore wind turbine are selected as a research object for numerical simulation, the waves of the near-field sea area of the offshore wind turbine are shown in FIG. 1, wherein, Φ is wave measuring equipment, and main parameters of the offshore wind turbine and the incident waves thereof are listed in Table 1. In the embodiment, a wave field of the near-field sea area of the offshore wind turbine is simulated through CFD software, and displacement time series xₙₐ (t) and displacement time series x_{nB} (t) at two positions, namely, wave measuring points A and B of a wave surface in vertical directions, are generated and exported, so as to simulate how the wave measuring equipment installed on the fixed offshore engineering structure acquires wave information of the near-field wave at the wave measuring points A and B. Applicable wave theories are selected by searching in a Meyer's Wave classification chart, when the measured wave is applicable to a linear theory, separation is performed based on a linear diffraction theory, and it proceeds to steps S3 to S5; and when the measured wave is applicable to a high-order wave theory, separation is performed based on a second-order diffraction theory in order to improve calculation efficiency, and it proceeds to steps S6 to S8.

When the measured wave is applicable to the linear theory, wave information x_{nd} (t) of one wave measuring point A is required according to step S3, a measured wave signal is decomposed based on a continuous wavelet transformation theory, and then an analytical signal of the measured wave can be obtained. A linear measuring wave surface of a near field of the fixed offshore engineering structure is written as superposition of a linear incidence wave surface and a linear diffraction wave surface according to step S4, a component occupied by incident waves in the linear measuring wave surface is calculated thereby, the analytical signal of the incident waves is obtained by multiplying the analytical signal of the measured wave by the component occupied by the incident waves in the linear measuring wave surface according to step S5, and an analytical signal of the linear incident waves can be obtained by wavelet inverse transformation.

When the measured wave is suitable for the linear theory, wave information xₙₐ (t) and wave information x_{nB} (t) of two wave measuring points A and B are required according to step S6, an analytical signal of the measured wave can be obtained by decomposing a measured wave signal based on the continuous wavelet transformation theory, the high-order measuring wave surface of the near field of the fixed offshore engineering structure can be regarded as superposition of the linear incident wave surface, the linear diffraction wave surface, the second-order incident wave surface and the second-order diffraction wave surface according to step S7, and the component occupied by the incident waves in the second-order measuring wave surface is calculated thereby. The analytical signal of the incident waves is obtained by multiplying the analytical signal of the measured wave by the component occupied by the incident waves in the high-order measuring wave surface according to step S8, and the time series of the high-order incident waves can be obtained through wavelet inverse transformation.

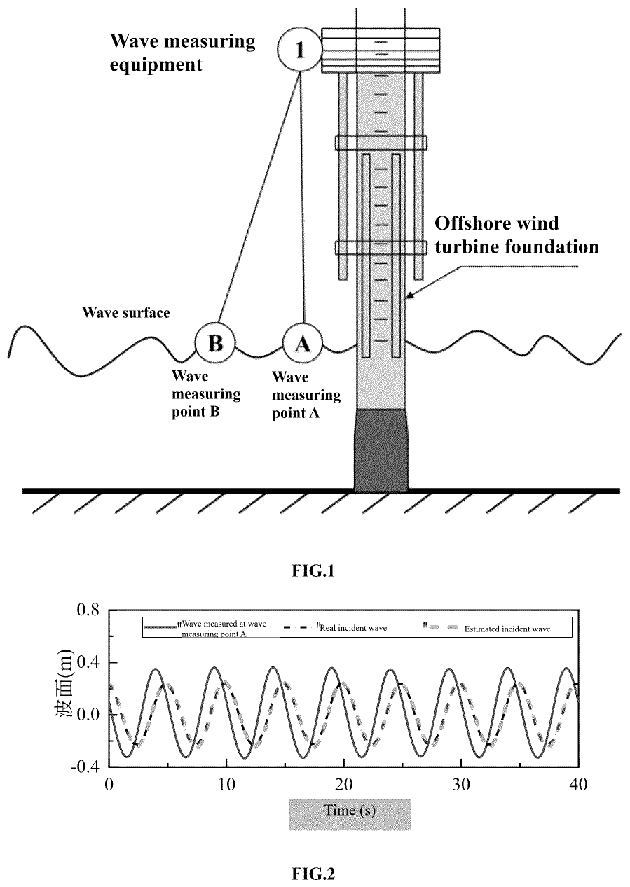

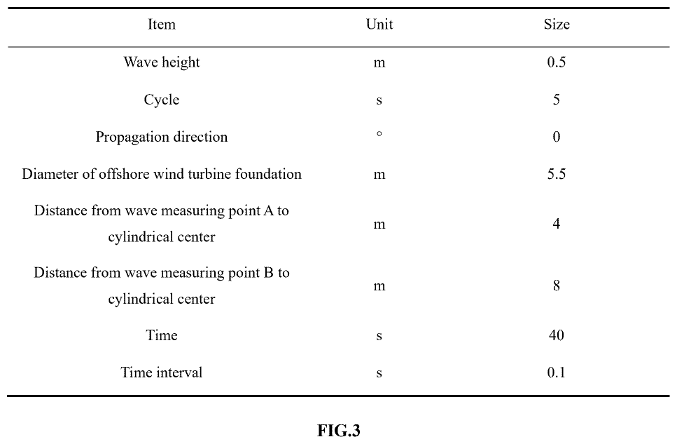

FIG. 2 shows comparison between an estimated incident wave and a real incident wave. It can be shown from the figure that the wave directly measured at the wave measuring point A greatly differs from the real incident wave, and the incident wave estimated by the technology of the present disclosure is basically consistent with the real incident wave. Therefore, it is shown that the method for extracting the near-field incident waves of the fixed offshore engineering structure provided by the present disclosure has a good application effect and high reliability.

In conclusion, in the present disclosure, the dimensionless wave height parameters and the dimensionless water depth parameters are calculated based on the measured wave information, and the applicable wave theories are selected according to the Meyer's wave classification chart; on this basis, the measured wave signals are decomposed based on the continuous wavelet transformation theory, to obtain the analytic signals of the measured waves at one or two wave measuring points; furthermore, the components occupied by the incident waves in disturbance waves are calculated based on the first-order diffraction theory and the second-order diffraction theory; and finally the wavelet signal time series is separated, wavelet inverse transformation is performed, and the near-field incident waves of the fixed offshore engineering structure are obtained.

Basic principles and main characteristics of the present disclosure and advantages of the present disclosure are shown and described above. It is obvious that the present disclosure is not limited to the details of the above exemplary embodiments for those skilled in the art, and the present disclosure can be implemented in other specific forms without departing from the spirit or basic characteristics of the present disclosure. Therefore, from any point of view, the embodiments should be considered to be exemplary and unrestricted. The scope of the present disclosure is defined by the accompanying claims rather than the above-mentioned description, and therefore all changes within the meaning and scope of the equivalents of the claims are included in the present disclosure.

In addition, it should be understood that, although the specification is described according to the implementations, not every implementation only contains one independent technical solution; such description of the specification is only for clearness; and those skilled in the art should regard the specification as a whole, and the technical solutions in each embodiment can also be properly combined to form other implementations which can be understood by those skilled in the art.

What is claimed is:

1. A method for extracting near-field incident waves of a fixed offshore engineering structure, comprising the following steps:
step 1, calculating a dimensionless wave height parameter and a dimensionless water depth parameter based on measured wave information, and selecting applicable wave theories according to a Meyer's wave classification chart;
step 2, decomposing measured wave signals based on a continuous wavelet transformation theory according to classification of the wave theories provided in step 1, to obtain analytic signals of measured waves at one or two wave measuring points;
step 3, calculating components occupied by incident waves in disturbance waves based on a first-order diffraction theory and a second-order diffraction theory according to the classification in step 1;
step 4, separating the wavelet signal analytic signals in step 2 according to a proportion of the components of the incident waves in step 3 for wavelet inverse transformation, to obtain the near-field incident waves of the fixed offshore engineering structure.

2. The method for extracting the near-field incident waves of the fixed offshore engineering structure according to claim 1, wherein in step 1:
a wave height H, a water depth d and a cycle T are obtained after statistics according to the measured wave information, and the dimensionless wave height parameter α and the dimensionless water depth parameter β are calculated:
$$α = \frac{H}{g {T}^{2}} \qquad ( 1 )$$
$$β = \frac{d}{{gT}^{2}} \qquad ( 2 )$$
where, g is a gravitational acceleration.

3. The method for extracting the near-field incident waves of the fixed offshore engineering structure according to claim 1, wherein according to the classification of the wave theories provided in step 1, when the measured waves are applicable to a linear theory, wave information x_{nA}(t) of one wave measuring point A is required; an analytic signal WT_{A}(s) of the measured wave is obtained by decomposing the measured wave signal based on the continuous wavelet transformation theory:
$${WT}_{A} ( s ) = {\sum }_{n = 0}^{N - 1} {x}_{n A} ( t ) ψ * ( \frac{( n - {n}^{′} ) δ t}{s} ) \qquad ( 3 )$$
where, * represents a conjugate complex,
a Morelet's wavelet is selected as a mother wavelet function ψ₀:
$${ψ}_{0} ( t ) = {π}^{- 0.25} {e}^{i {ω}_{0} t} {e}^{- {t}^{2} / 2} \qquad ( 4 )$$
where, π is a ratio of a circle's circumference to its diameter, e is an exponential function, ω₀ is a center circle frequency, t is time, i is a complex symbol,
a nondimensionalized mother wavelet function y is obtained by nondimensionalizing the mother wavelet function ψ₀:
$$ψ ( \frac{( n - {n}^{′} ) δ t}{s} ) = {( \frac{δ t}{s} )}^{0.5} {ψ}_{0} ( \frac{( n - {n}^{′} ) δ t}{s} ) \qquad ( 5 )$$
where, n′ is a time translation, n is an nth measured wave signal point,
then a group of scale factors s need to be selected in order to complete wavelet transformation:
$${s}_{j} = {s}_{0} {2}^{j δ j} , j = 0 , 1 , 2 , … , J , \qquad ( 6 )$$
where, sⱼ is a jth scale factor, so is a minimum scale factor, taken as 2δt, and δt is a time step length; δj is a scale parameter, taken as 0.5; J is a maximum scale factor:
$$J = \frac{1}{δ j} {log}_{2} ( \frac{N δ t}{{s}_{0}} ) \qquad ( 7 )$$
where, N is a length of the measured wave signal;
each wavelet scale sⱼ corresponds to a circular frequency @j at the scale under the Morelet's wavelet:
$${ω}_{j} = \frac{{ω}_{0} + {( {ω}_{0}^{2} + 2 )}^{1 / 2}}{2 {s}_{j}} \qquad ( 8 )$$
according to the classification of the wave theories provided in step 1, when the measured waves are applicable to a high-order wave theory, wave information x_{nA}(t) and wave information x_{nB} (t) of two wave measuring points A and B are required; and analytic signals WT_{A}(s) and WT_{B}(s) of the measured waves are obtained by decomposing the measured wave signals based on the continuous wavelet transformation theory according to a selected mother wavelet function and scale factor:
$${WT}_{A} ( s ) = {\sum }_{n = 0}^{N - 1} {x}_{nA} ( t ) ψ * ( \frac{( n - {n}^{′} ) δ t}{s} ) \qquad ( 9 )$$
$${WT}_{B} ( s ) = {\sum }_{n = 0}^{N - 1} {x}_{n B} ( t ) ψ * ( \frac{( n - {n}^{′} ) δ t}{s} ) . \qquad ( 10 )$$

4. The method for extracting the near-field incident waves of the fixed offshore engineering structure according to claim 1, wherein in step 3:
according to the classification of the wave theories provided in step 1, when the measured waves are applicable to a linear wave theory, a linear measured wave surface η⁽¹⁾ of a near field of the fixed offshore engineering structure is regarded as superposition of a linear incident wave surface η₁⁽¹⁾ and a linear diffraction wave surface η_{D}⁽¹⁾ based on a linear diffraction theory:
$${η}^{( 1 )} = {η}_{I}^{( 1 )} + {η}_{D}^{( 1 )} \qquad ( 11 )$$
$$where ,$$
$${η}_{1}^{( 1 )} = A [ {f}_{0} ( z ) {\sum }_{m = 0}^{∞} {ε}_{m} {i}^{m} {J}_{m} ( {k}_{0} r ) cos m θ ] {e}^{i ω t} \qquad ( 12 )$$
$${η}_{D}^{( 1 )} = - A {f}_{0} ( z ) [ {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ ] {e}^{i ω t} \qquad ( 13 )$$
$$where ,$$
$${ε}_{m} = \{ \begin{matrix}1 & m = 0 \\ 2 {i}^{m} & m > 0\end{matrix} \qquad ( 14 )$$
where, A is a wave amplitude, Jₘ (k₀r) represents an m-order Bessel function of the first kind for k₀r, Hₘ (k₀r) represents an m-order Hankel function of the first kind for k₀r, a first-order wave number k₀ is a positive real root of an equation ktankd=v, where,
$$v = \frac{{ω}^{2}}{g} ,$$
r represents a distance from a wave measuring point to a circle center of the fixed offshore engineering structure, R represents a radius of the fixed offshore engineering structure, θ represents an incidence angle of the wave, ω represents a circular frequency of the wave, and f₀(z) represents a first-order vertical function:
$${f}_{0} ( z ) = \frac{cosh {k}_{0} ( z + d )}{cosh {k}_{0} d} \qquad ( 15 )$$
where, z is a vertical position of the wave measuring point, cosh is a hyperbolic cosine function,
a component p₁ occupied by incident waves in a linear measuring wave surface is:
$${p}_{1} = \frac{{η}_{I}^{( 1 )}}{{η}_{I}^{( 1 )} + {η}_{D}^{( 1 )}} = \frac{{{\sum }^{∞}}_{m = 0} {ε}_{m} {i}^{m} {J}_{m} ( {k}_{0} r ) cos m θ}{\begin{matrix}{\sum }_{m = 0}^{∞} {ε}_{m} {i}^{m} {J}_{m} ( {k}_{0} r ) cos m θ + \\ {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ\end{matrix}} \qquad ( 16 )$$
according to the classification of the wave theories provided in step 1, when the measured, waves are applicable to a high-order theory, a high-order measured wave surface η⁽²⁾ of the near field of the fixed offshore engineering structure is regarded as superposition of the linear incident wave surface η₁⁽¹⁾, the linear diffraction wave surface η_{D}⁽¹⁾, a second-order incident wave surface n₁⁽²⁾ and a second-order diffraction wave surface η_{D}⁽²⁾ based on a second-order diffraction theory:
$${η}^{( 2 )} = {η}_{I}^{( 1 )} + {η}_{D}^{( 1 )} + {η}_{I}^{( 2 )} + {η}_{D}^{( 2 )} \qquad ( 17 )$$
$$where ,$$
$${η}_{I}^{( 1 )} = \frac{i ω}{g} {φ}_{I}^{( 1 )} {e}^{i ω t} \qquad ( 18 )$$
$${η}_{D}^{( 1 )} = \frac{i ω}{g} {φ}_{D}^{( 1 )} {e}^{i ω t} \qquad ( 19 )$$
$${η}_{I}^{( 2 )} = \frac{2 i ω}{g} {φ}_{D}^{( 2 )} {e}^{2 i ω t} \qquad ( 20 )$$
$${η}_{D}^{( 2 )} = ( \frac{2 i ω}{g} {φ}_{D}^{( 2 )} - \frac{1}{4 g} ∇ {φ}^{( 1 )} \cdot ∇ {φ}^{( 1 )} - \frac{{v}^{2}}{2 g} {φ}^{( 1 )} {φ}^{( 1 )} ) {e}^{2 i ω t} \qquad ( 21 )$$
where, ∇ is a gradient operator,
a second-order incidence velocity potential φ₁⁽²⁾;
$${φ}_{I}^{( 2 )} = - \frac{3 i ω {A}^{2}}{8} \frac{cosh 2 {k}_{0} ( z + d )}{{sinh}^{4} {k}_{0} d} {\sum }_{m = 0}^{∞} {ε}_{m} {i}^{m} {J}_{m} ( 2 {k}_{0} r ) cos m θ \qquad ( 22 )$$
where, sinh is a hyperbolic sine function, cosh is a hyperbolic cosine function,
a second-order diffraction velocity potential φ_{D}⁽²⁾;
$$\begin{matrix}{φ}_{D}^{( 2 )} = {\sum }_{m = 0}^{∞} {ε}_{m} \{ {f}_{0}^{( 2 )} ( z ) {β}_{m 0} {H}_{m} ( {κ}_{0} r ) + {\sum }_{n = 1}^{∞} {f}_{n}^{( 2 )} ( z ) {β}_{m n} {K}_{m} ( {κ}_{n} r ) \\ + π i {C}_{0} {f}_{0}^{( 2 )} ( z ) {H}_{m} ( {κ}_{0} r ) {\int }_{R}^{r} [ {J}_{m} ( {κ}_{0} ρ ) - \frac{{J}_{m}^{′} ( {κ}_{0} R )}{{H}_{m}^{′} ( {κ}_{0} R )} {H}_{m} ( {κ}_{0} ρ ) ] {Q}_{D m} ( ρ ) ρ d ρ \\ + 2 {\sum }_{n = 1}^{∞} {C}_{n} {f}_{n}^{( 2 )} ( z ) {K}_{m} ( {κ}_{m} r ) {\int }_{R}^{r} [ {I}_{m} ( {κ}_{n} ρ ) - \frac{{I}_{m}^{′} ( {κ}_{n} R )}{{K}_{m}^{′} ( {κ}_{n} R )} {K}_{m} ( {κ}_{n} ρ ) ] {Q}_{D m} ( ρ ) ρ d ρ\end{matrix} \qquad ( 23 )$$
$$\begin{matrix}+ π i {C}_{0} {f}_{0}^{( 2 )} ( z ) [ {J}_{m} ( {κ}_{0} r ) - \frac{{J}_{m}^{′} ( {κ}_{0} R )}{{H}_{m}^{′} ( {κ}_{0} R )} {H}_{m} ( {κ}_{0} r ) ] {\int }_{r}^{∞} {H}_{m} ( {κ}_{0} ρ ) {Q}_{D m} ( ρ ) ρ d ρ \\ + 2 {\sum }_{n = 1}^{∞} {C}_{n} {f}_{n}^{( 2 )} ( z ) [ {I}_{m} ( {κ}_{n} r ) - \frac{{I}_{m}^{′} ( {κ}_{n} R )}{{K}_{m}^{′} ( {κ}_{n} R )} {K}_{m} ( {κ}_{n} r ) ] {\int }_{r}^{∞} {K}_{m} ( {κ}_{n} ρ ) {Q}_{D m} ( ρ ) ρd ρ \} cos m θ\end{matrix}$$
where, Kₘ (Kₙr) represents an m-order Bessel function of the second kind with complex argument for Kₙr, Iₘ (Kₙr) represents an m-order Bessel function of the first kind with complex argument for Kw, a second-order wave number K₀ is a positive real root of an equation Ktankd=4v, Kₙ is an nth positive real root of an equation ktankd=−4v, p is a distance from the circle center of the offshore engineering structure to an integration point,
f₀⁽²⁾ (z) and fₙ⁽²⁾ (z) represent second-order vertical functions:
$${f}_{0}^{( 2 )} ( z ) = \frac{cos {κ}_{0} ( z + d )}{cos {κ}_{0} d} \qquad ( 24 )$$
$${f}_{n}^{( 2 )} ( z ) = \frac{cos {κ}_{n} ( z + d )}{cos {κ}_{n} d} \qquad ( 25 )$$
coefficients C₀ and Cₙ are as follows:
$${C}_{0} = {[ 2 {\int }_{- d}^{0} {f}_{0}^{{( 2 )}_{2}} ( z ) dz ]}^{- 1} \qquad ( 26 )$$
$${C}_{n} = {[ 2 {\int }_{- d}^{0} {f}_{n}^{{( 2 )}_{2}} ( z ) dz ]}^{- 1} \qquad ( 27 )$$
coefficients βₘ₀ and βₘₙ are as follows:
$${β}_{m 0} = - \frac{2 {C}_{0}}{{κ}_{0} {H}_{m}^{′} ( {κ}_{0} R ) ( 4 {k}_{0}^{2} - {κ}_{0}^{2} )} \frac{\partial {φ}_{Im}^{( 2 )}}{\partial r} ( R ) \qquad ( 28 )$$
$${β}_{m 0} = - \frac{2 {C}_{n}}{{κ}_{n} {K}_{m}^{′} ( {κ}_{n} R ) ( 4 {k}_{0}^{2} + {κ}_{n}^{2} )} \frac{\partial {φ}_{Im}^{( 2 )}}{\partial r} ( R ) \qquad ( 29 )$$
where, φ₁ₘ⁽²⁾(R) is an m-order Fourier component of a second-order incidence potential on a cylindrical wall surface:
$${φ}_{Im}^{( 2 )} ( R ) = \frac{3 i ω {A}^{2}}{2} \frac{v}{{sinh}^{2} {k}_{0} d} {i}^{m} {J}_{m} ( 2 {k}_{0} R ) \qquad ( 30 )$$
Q_{Dm} is an m-order Fourier coefficient of a non-homogeneous term Q_{D} for a free surface:
$${Q}_{D} = \text{} \frac{i ω}{2 g} ( 3 {v}^{2} - {k}_{0}^{2} ) ( {φ}_{D}^{{( 1 )}^{2}} + 2 {φ}_{I}^{( 1 )} {φ}_{D}^{( 1 )} ) + \frac{i ω}{g} ( {∇}_{0} {φ}_{D}^{( 1 )} \cdot {∇}_{0} {φ}_{D}^{( 1 )} + 2 {∇}_{0} {φ}_{I}^{( 1 )} \cdot {∇}_{0} {φ}_{D}^{( 1 )} ) \qquad ( 31 )$$
where, ∇₀ is a horizontal gradient operator,
a first-order incidence velocity potential φ₁⁽¹⁾;
$${φ}_{I}^{( 1 )} = - \frac{i g A}{ω} {f}_{0} ( z ) {\sum }_{m = 0}^{∞} {ε}_{m} {i}^{m} {J}_{m} ( {k}_{0} r ) cos m θ \qquad ( 32 )$$
a first-order diffraction velocity potential φ_{D}⁽¹⁾;
$${φ}_{D}^{( 1 )} = \frac{i g A}{ω} {f}_{0} ( z ) {\sum }_{m = 0}^{∞} {ε}_{m} {i}^{m} \frac{{J}_{m}^{′} ( {k}_{0} R )}{{H}_{m}^{′} ( {k}_{0} R )} {H}_{m} ( {k}_{0} r ) cos m θ \qquad ( 33 )$$
a first-order total velocity potential φ⁽¹⁾;
$${φ}^{( 1 )} = \frac{i g A}{ω} {f}_{0} ( z ) {\sum }_{m = 0}^{∞} {ε}_{m} {i}^{m} [ - {J}_{m} ( {k}_{0} r ) + \frac{{J}_{m}^{′} ( {k}_{0} R )}{{H}_{m}^{′} ( {k}_{0} R )} {H}_{m} ( {k}_{0} r ) ] cos m θ \qquad ( 34 )$$
since each component of wavelet transformation in step S2 corresponds to the same circular frequency ω, a second-order wave surface needs to be adjusted, and in the event of ω₂=ω/2, Formula (17) may be written in the following form:
$$η = {η}_{I}^{( 1 )} {\vert}_{ω} + {η}_{D}^{( 1 )} {\vert}_{ω} + {η}_{I}^{( 2 )} {\vert}_{{ω}_{2}} + {η}_{D}^{( 2 )} {\vert}_{{ω}_{2}} \qquad ( 35 )$$
where,
$${{{η}_{I}^{( 1 )} \vert}_{ω} and {η}_{D}^{( 1 )} \vert}_{ω}$$
are linear incidence and diffraction wave surfaces respectively when the circular frequency is ω,
$${η}_{I}^{( 2 )} {\vert}_{{ω}_{2}} and {η}_{D}^{( 2 )} {\vert}_{{ω}_{2}}$$
are second-order incidence and diffraction wave surfaces respectively when the circular frequency is ω₂,
at this moment, since the wave amplitudes are indecomposable, measured wave data of two wave measuring points is required for inversely deducing a first-order wave amplitude A⁽¹⁾ and a second-order wave amplitude A⁽²⁾, the wave amplitude in Formula (35) is independently extracted in order to facilitate description, wave surfaces η_{A} and η_{B} of the two wave measuring points A and B in Formula (35) may be written in the following form:
$${η}_{A} = {A}^{( 1 )} ( \frac{{η}_{IA}^{( 1 )} {\vert}_{ω} + {η}_{D A}^{( 1 )} {\vert}_{ω}}{{A}^{( 1 )}} ) + {A}^{( 2 ) 2} ( \frac{{η}_{IA}^{( 2 )} {\vert}_{{ω}_{2}} + {η}_{D A}^{( 2 )} {\vert}_{{ω}_{2}}}{{A}^{( 2 ) 2}} ) \qquad ( 36 )$$
$${η}_{B} = {A}^{( 1 )} ( \frac{{η}_{IB}^{( 1 )} {\vert}_{ω} + {η}_{D B}^{( 1 )} {\vert}_{ω}}{{A}^{( 1 )}} ) + {A}^{( 2 ) 2} ( \frac{{η}_{IB}^{( 2 )} {\vert}_{{ω}_{2}} + {η}_{D B}^{( 2 )} {\vert}_{{ω}_{2}}}{{A}^{( 2 ) 2}} ) \qquad ( 37 )$$
where,
$$\frac{{η}_{IA}^{( 1 )} {\vert}_{ω} + {η}_{D A}^{( 1 )} {\vert}_{ω}}{{A}^{( 1 )}} and \frac{{η}_{IB}^{( 1 )} {\vert}_{ω} + {η}_{D B}^{( 1 )} {\vert}_{ω}}{{A}^{( 1 )}}$$
can be solved by substituting w and position information (known conditions) of the wave measuring points A and B into Formula (18) and Formula (19) respectively, and
$$\frac{{η}_{IA}^{( 2 )} {\vert}_{{ω}_{2}} + {η}_{D A}^{( 2 )} {\vert}_{{ω}_{2}}}{{A}^{( 2 ) 2}} and \frac{{η}_{IB}^{( 2 )} {\vert}_{{ω}_{2}} + {η}_{D B}^{( 2 )} {\vert}_{{ω}_{2}}}{{A}^{( 2 ) 2}}$$
can be solved by substituting ω₂ and the position information (known conditions) of the wave measuring points A and B into Formula (20) and Formula (21) respectively; where,
$${{{η}_{IA}^{( 1 )} \vert}_{ω} and {η}_{IB}^{( 1 )} \vert}_{ω}$$
are linear incidence wave surfaces of the wave measuring points A and B respectively when the circular frequency is ω,
$${{{η}_{DA}^{( 1 )} \vert}_{ω} and {η}_{DB}^{( 1 )} \vert}_{ω}$$
and are linear diffraction wave surfaces of the wave measuring points A and B respectively when the circular frequency is ω,
$${η}_{IA}^{( 2 )} {\vert}_{{ω}_{2}} and {η}_{IB}^{( 2 )} {\vert}_{{ω}_{2}}$$
are second-order incidence wave surfaces of the wave measuring points A and B respectively when the circular frequency is ω₂,
$${η}_{D A}^{( 2 )} {\vert}_{{ω}_{2}} and {η}_{D B}^{( 2 )} {\vert}_{{ω}_{2}}$$
are second-order diffraction wave surfaces of the wave measuring points A and B respectively when the circular frequency is ω₂, and
meanwhile, wave surface information of right sides in Formula (36) and Formula (37) can be obtained through wavelet decomposition, namely, the analytical signals WT_{A}(s) and WT_{B}(s) of the measured waves in Formula (9) and Formula (10); and the first-order wave amplitude A⁽¹⁾ and the second-order wave amplitude A⁽²⁾ can be obtained by solving the simultaneous equations (36) and (37), and
a component p₂ occupied by incident waves in a second-order measuring wave surface is:
$${p}_{2} = \frac{{η}_{IA}^{( 1 )} {\vert}_{ω} + {η}_{IA}^{( 2 )} {\vert}_{ω}}{{η}_{IA}^{( 1 )} {\vert}_{ω} + {η}_{D A}^{( 1 )} {\vert}_{ω} + {η}_{IA}^{( 2 )} {\vert}_{{ω}_{2}} + {η}_{D A}^{( 2 )} {\vert}_{{ω}_{2}}} . \qquad ( 38 )$$

5. The method for extracting the near-field incident waves of the fixed offshore engineering structure according to claim 1, wherein in step 4:
according to the classification of the wave theories provided in step 1, when the measured waves are applicable to a linear wave theory, the analytical signal WT_{A}(s) of the measured wave in step 4 is shown in Formula (8), a component p₁ occupied by incident waves in a linear measuring wave surface is shown in Formula (16), and an analytical signal WT₁⁽¹⁾ (s) of the incident waves may be obtained by multiplying both of the above:
$${WT}_{I}^{( 1 )} ( s ) = {p}_{1} {WT}_{A} ( s ) \qquad ( 37 )$$
an analytical signal WT₁⁽¹⁾(s) of a linear incident wave corresponding to each wavelet WT (1) scale sⱼ is as follows:
$${WT}_{I}^{( 1 )} ( {s}_{j} ) = {p}_{j 1} {WT}_{A} ( {s}_{j} ) \qquad ( 38 )$$
where, pⱼ₁ is a component occupied by incident waves in the linear measuring wave surface corresponding to each wavelet scale sⱼ:
$${p}_{j 1} = \frac{{\sum }_{m = 0}^{∞} {ε}_{m} {i}^{m} {J}_{m} ( {k}_{0 j} r ) cos m θ}{{\sum }_{m = 0}^{∞} {ε}_{m} {i}^{m} {J}_{m} ( {k}_{0 j} r ) cos m θ + {\sum }_{m = 0}^{∞} {ε}_{m} {i}^{m} \frac{{J}_{m}^{′} ( {k}_{0 j} R )}{{H}_{m}^{′} ( {k}_{0 j} R )} {H}_{m} ( {k}_{0 j} r ) cos m θ} \qquad ( 39 )$$
a circular frequency ωⱼ corresponding to each wavelet scale sⱼ can be obtained by Formula (8), a wave number k₀ⱼ corresponding to each wavelet scale sⱼ in Formula (39) can be obtained according to a dispersion relationship under a limited water depth:
$${k}_{j} = \frac{{ω}_{j}}{{( g d )}^{1 / 2}} = \frac{{ω}_{0} + {( {ω}_{0}^{2} + 2 )}^{1 / 2}}{2 {{s}_{j} ( g d )}^{1 / 2}} \qquad ( 40 )$$
the analytical signal x₁⁽¹⁾(t) of the linear incident wave can be obtained by performing wavelet inverse transformation on WT₁⁽¹⁾(sⱼ),
$${x}_{I}^{( 1 )} ( t ) = \frac{δ j δ {t}^{1 / 2}}{{C}_{δ} {ψ}_{0} ( 0 )} {\sum }_{j = 0}^{J} \frac{{WT}_{I}^{( 1 )} ( {s}_{j} )}{{s}_{j}^{1 / 2}} \qquad ( 41 )$$
according to the classification of the wave theories provided in step 1, when the measured waves are applicable to a high-order wave theory, the analytical signal WT_{A}(s) of the measured wave in step 4 is shown in Formula (9), a component p₂ occupied by incident waves in a high-order measuring wave surface is shown in Formula (36), and an analytical signal WT₁⁽²⁾(s) of the high-order incident waves may be obtained by multiplying both of the above:
$${WT}_{I}^{( 2 )} ( s ) = {p}_{2} {WT}_{A} ( s ) \qquad ( 42 )$$
an analytical signal WT₁⁽²⁾ (sⱼ) of a high-order incident wave corresponding to each wavelet scale sⱼ is as follows:
$${WT}_{I}^{( 2 )} ( {s}_{j} ) = {p}_{j 2} W {T}_{A} ( {s}_{j} ) \qquad ( 43 )$$
where, pⱼ₂ is a component occupied by incident waves in the high-order measuring wave surface corresponding to each wavelet scale sⱼ, which is obtained by substituting the circular frequency ω, corresponding to each wavelet scale sⱼ, obtained by Formula (8) into Formula (36):
$${p}_{j 2} = \frac{{η}_{IA}^{( 1 )} {\vert}_{{ω}_{j}} + {η}_{IA}^{( 2 )} {\vert}_{{ω}_{j}}}{{η}_{IA}^{( 1 )} {\vert}_{{ω}_{j}} + {η}_{D A}^{( 1 )} {\vert}_{{ω}_{j}} + {η}_{IA}^{( 2 )} {\vert}_{{ω}_{j 2}} + {η}_{D A}^{( 2 )} {\vert}_{{ω}_{j 2}}} \qquad ( 44 )$$
$$where , {ω}_{j 2} = {ω}_{j} / 2 ,$$
a time series x₁⁽¹⁾(t) of the high-order incident waves can be obtained by performing wavelet inverse transformation on WT₁⁽²⁾(s).
$${x}_{I}^{( 2 )} ( t ) = \frac{δ j δ {t}^{1 / 2}}{{C}_{δ} {ψ}_{0} ( 0 )} {\sum }_{j = 0}^{J} \frac{{WT}_{I}^{( 2 )} ( {s}_{j} )}{{s}_{j}^{1 / 2}} . \qquad ( 45 )$$
